(19) United States
(12) Patent Application Publication
(10) Pub. No.: US 2026/0108814 A1
(43) Pub. Date: Apr. 23, 2026

(54) User Defined Level Generation

(71) Applicant: Sony Interactive Entertainment Inc., Tokyo (JP)

(72) Inventors: Chockalingam Ravi Sundaram, San Mateo, CA (US); Doron Griss, San Mateo, CA (US); Murshed Choudhury, San Mateo, CA (US); Edward Yet Bunn Cheung, San Mateo, CA (US); Aaron Kulka, San Mateo, CA (US)

(21) Appl. No.: 18/919,301

(22) Filed: Oct. 17, 2024

(51) Int. Cl. A63F 13/67

(52) U.S. Cl. CPC A63F 13/67; A63F 2300/6027

(57) ABSTRACT

Techniques are provided for establishing a baseline computer game level for a particular gamer based on the gamer's playing habits and characteristics. If the gamer is having only a modicum of success or is experiencing difficulty, the game remains tailored to the gamer's habits and characteristics. Once the gamer achieves success, the game level may move away from the gamer's strengths to pose more challenge to the gamer. If the gamer experiences undue lack of success or frustration the game can revert to catering to the gamer's personal style.

### FIELD

The present application relates generally to user defined level generation for computer simulations such as computer games.

### BACKGROUND

Computer simulations such as computer games typically offer multiple “levels” of game play that provide successively more difficult challenges to the computer gamer.

### SUMMARY

As understood herein, changing computer game levels typically is done based solely on whether a gamer has achievements at a lower level that propel him to a higher level of game play. As also understood herein, the game experience can be enhanced by tailoring presentation of a computer game to a particular style of play of a gamer and then challenging the gamer by penalizing his style of play once he begins to achieve easy success.

Accordingly, an apparatus includes at least one processor system configured to establish a first game level style of a computer simulation to be consistent with identified play style of a first gamer. The play style of the first gamer includes a passive style, and the first game level style rewards passive play. The processor system is configured to, responsive to game play success of the first gamer at the first game level style, change to a second game level style comprising rewarding aggressive play. Also, the processor system is configured to, responsive to success of the first gamer playing the second game level style not satisfying a threshold and/or responsive to identifying negative emotion of the first gamer, revert to the first game level style.

The negative emotion may be, e.g., anger or frustration.

In some examples the passive style includes a strategy of fleeing from danger in the computer simulation. In other examples the passive style can include a strategy of hiding from danger in the computer simulation. The aggressive play can include a strategy of confronting danger in the computer simulation.

If desired, the processor system may be configured to execute a machine learning (ML) model to identify the play style of the first gamer.

In another aspect, an apparatus includes at least one computer memory that is not a transitory signal and that in turn includes instructions executable by at least one processor system to identify a game play style of a first gamer, and present a computer simulation at a first level rewarding the game play style of the first gamer. The instructions also are executable to, responsive to success of the first gamer playing the simulation at the first level, present the computer simulation at a second level penalizing the game play style of the first gamer. The instructions are executable to revert to presenting the computer simulation at the first level responsive to the first gamer playing at the second level not satisfying a threshold of success and/or responsive to the first gamer exhibiting negative emotion.

In another aspect, a method includes tailoring presentation of a computer simulation to reward a game style of a first gamer that is learned by a machine learning (ML) model from game play of the first gamer. The method also includes tailoring presentation of the computer simulation to penalize the game style of the first gamer responsive to the first gamer achieving success satisfying a threshold.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 illustrates an example specific simulation system;

FIG. 3 illustrates example initial logic in example flow chart format;

FIG. 4 illustrates an example screen shot of initial game play consistent with FIG. 3;

FIG. 5 illustrates example post-initial logic in example flow chart format;

FIG. 6 illustrates example training logic for training a machine learning (ML) model to change game thread/levels based on user game play styles;

FIG. 7 illustrates additional example logic in example flow chart format for maintaining the overall scheme of a game in place;

FIG. 8 illustrates an example sensor system for determining player emotion;

FIG. 9 illustrates example training logic for training a ML model to determine emotion from input from one or more of the sensors of FIG. 8; and

FIG. 10 illustrates an example table or other data structure consistent with present principles.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single-or multi-chip processor that can execute logic by means of various lines such as address lines, data lines, and control lines and registers and shift registers. A processor including a digital signal processor (DSP) may be an embodiment of circuitry. A processor system may include one or more processors.

Components included in one embodiment can be used in other embodiments in any appropriate combination. For example, any of the various components described herein and/or depicted in the Figures may be combined, interchanged, or excluded from other embodiments. “A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

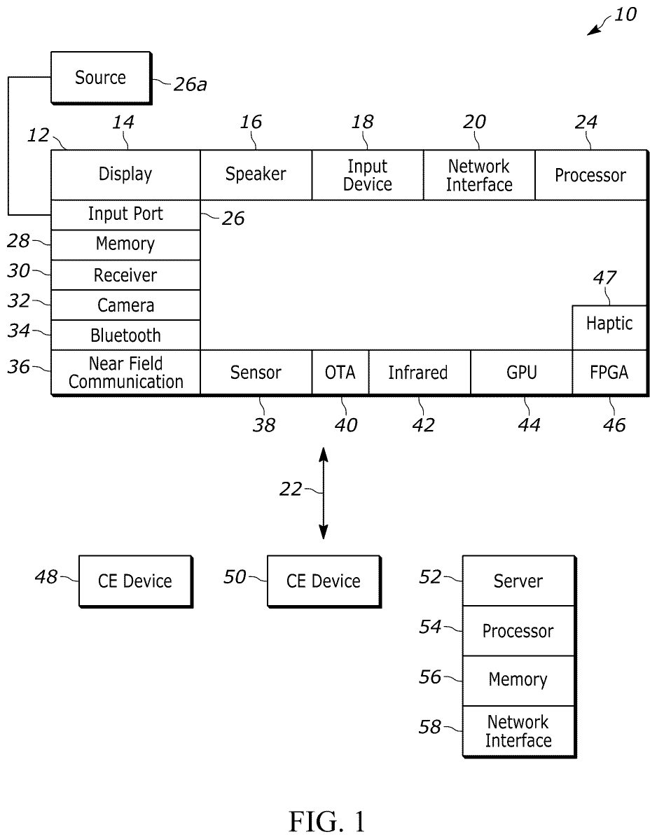

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Large language models (LLM) such as generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that are configured and weighted to make inferences about an appropriate output.

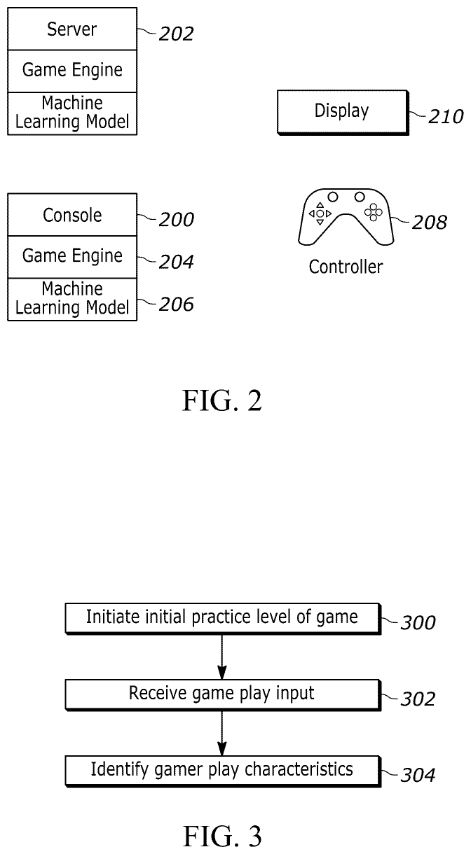

Refer now to FIG. 2, which illustrates a system that dynamically generates game levels by analyzing types of paths and other navigational preferences (climb walls, avoid obstacles) a gamer has as well as the gamer's playing style (for example, fight v. stealth). Easier levels cater to gamer styles, harder levels more away from it. The system continuously learns the gamer's style and adjusts game levels accordingly.

In FIG. 2, a source of computer games such as a computer game console 200 and/or cloud-based game server 202 host one or more computer simulation programs referred to as computer game engines 204. The output of the game engine 204 may be modified during game play by one or more machine learning (ML) models 206 according to the style of play of the person playing the game using an input device such as a cell phone or, as shown, a computer game control 208. The game is presented on a display 210.

FIG. 3 shows that at state 300, an initial evaluation game level is established based on any initial information about the particular gamer playing the game that might be available. If no initial gamer information is known a default level is established. Moving to state 302, game play input is received from, e.g., the controller 208 in FIG. 2 and correlated to game play style or strategy based on what actions the signals cause a player character (PC) or other character to take in known game scenarios. The game play characteristics/style of the gamer is thus identified at state 304.

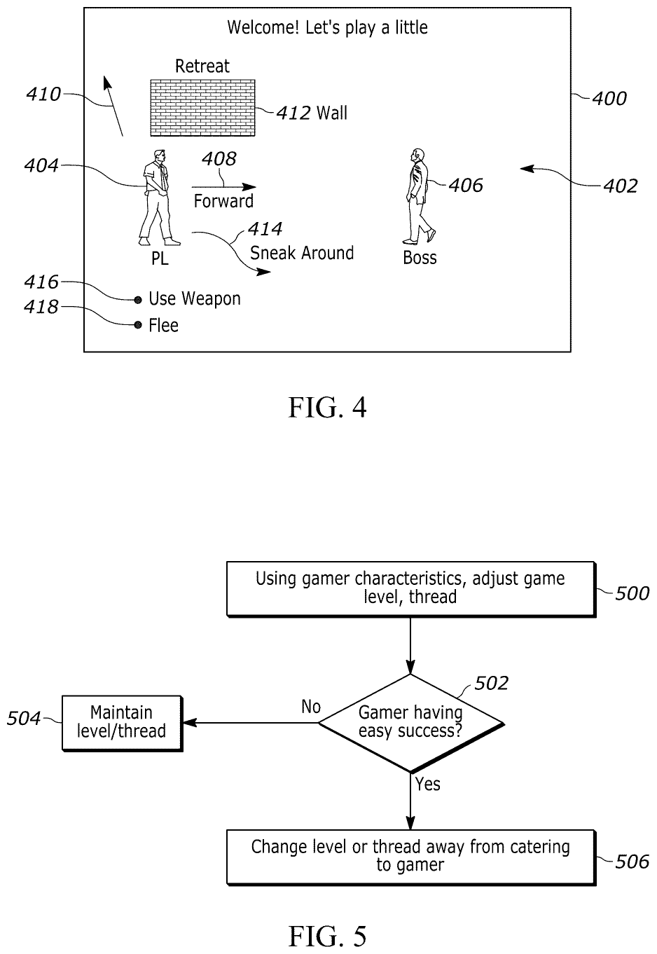

FIG. 4 provides an illustration of the technique in FIG. 3. A display 400 such as any display herein may present a computer simulation 402 such as a computer game in an initial training level. As shown, a PC 404 is controlled by the gamer to confront a game character 406 who is an adversary of the PC 404. The gamer may elect to aggressively move the PC 404 toward the game character 406 as indicated by the arrow 408. Or, the gamer may elect to cause the PC to flee from the game character 406 as indicated by the arrow 410, if necessary by scaling a game wall 412. Yet again, the gamer may elect to cause the PC to sneak around the game character 406 as indicated by the arrow 414. The gamer may select 416 to aggressively use a weapon against the game character 406 or may select 418 to flee from the game character 406. Depending on these selections and decisions, the gamer's style/characteristics of game play may be determined by the ML model 206 shown in FIG. 2.

FIG. 5 illustrates game logic after the gamer's personal play characteristics/style of game play have been determined. Commencing at state 500, using the gamer's learned game play style, the game level and/or game thread is established. For example, for a gamer who is timid, a low level of game difficulty may be established and/or the game engine may output a game modified to cater to timidity by, for instance, presenting the game with more hiding places than a baseline version of the game, and giving the gamer more time than a baseline presentation might allocate for that scene. On the other hand, for a gamer who is aggressive, a high level of game difficulty may be established and/or the game engine may output a game modified to cater to boldness by, for instance, presenting the game with a more aggressive game character 406 than would the game character 406 have for an unmodified version of the game and giving the gamer less time to complete the scene than otherwise would have been allocated in the unmodified version of the game.

Proceeding to decision state 502, if it is determined, e.g., based on number of boss kills, success in evading a boss character, time to achieve a boss kill, survival time, etc. that the gamer is not achieving success, the same level and/or game thread may be, maintained at state 504 to give the gamer the chance to learn the game at a level tailored to cater to the gamer's style. On the other hand, if the gamer is finding success relatively easy as indicated by one or more indicia of success satisfying a threshold, the logic may move to state 506 to change the level and/or game thread away from catering to the style of game play of the gamer, to make the game more challenging. Should the gamer become unsuccessful at state 506 or exhibit frustration consistent with disclosure below, the game presentation may revert to the presentation it had at state 500.

Thus, a first game level style of a computer simulation is established to be consistent with the identified play style of the gamer, which in one example may be a passive or timid. The first game level style rewards passive or timid play. Responsive to game play success of the gamer at the first game level style, game presentation is changed to a second game level style that rewards, in this example, aggressive play, and responsive to success of the gamer playing the second game level style not satisfying a threshold and/or responsive to identifying negative emotion of the first gamer, the first game level style is reverted to.

Stated more generally, a computer simulation is presented at a first level rewarding the game play style of the gamer, and then responsive to success of the gamer playing the simulation at the first level, the computer simulation is presented at a second level that penalizes the game play style of the gamer. Present principles may revert to presenting the computer simulation at the first level responsive to the gamer playing at the second level not satisfying a threshold of success and/or responsive to the gamer exhibiting negative emotion, which may include frustration and/or anger.

It may now be appreciated that in examples, a passive style of game play may include a strategy of fleeing from danger in the computer simulation, and/or hiding from danger in the computer simulation, whereas an aggressive play style may include a strategy of confronting danger in the computer simulation.

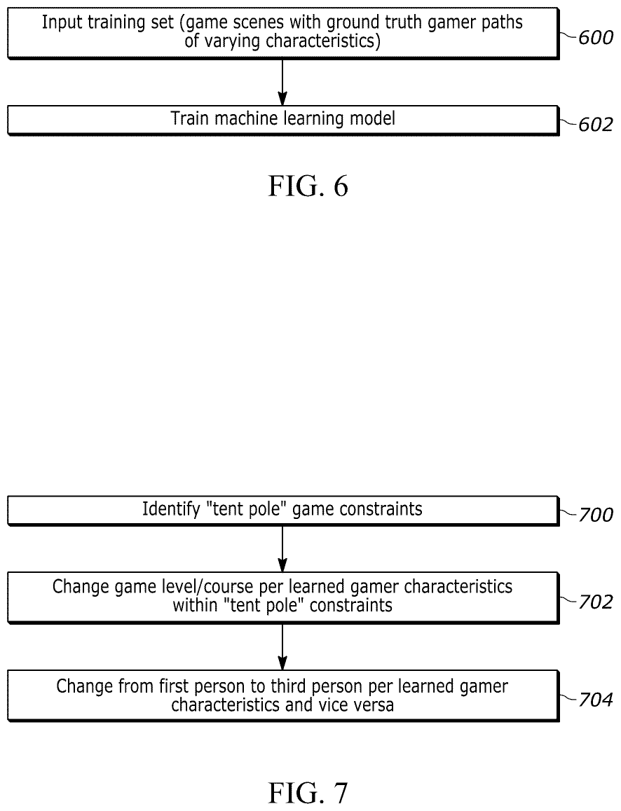

To achieve the above, the ML model(s) herein may be trained as indicated in the example technique of FIG. 6. A training set of game scenes along with ground truth examples of gamer paths/decisions and correlations of those paths and decisions to game play style is input to the model at state 600 to train the model at state 602. A wide variety of game scenes with corresponding ground truth gamer play styles may be used.

If desired, while tailoring game level and/or thread to gamer style is contemplated, the amount a game engine may change the thread or game narrative to tailor it to a particular gamer's style may be cabined by what may be referred to as “tent poles” to constrain the amount by which the ML model may change the game to suit a particular gamer. FIG. 7 illustrates.

Commencing at state 700, the tent pole constraints are identified. For example, a maximum number of hiding spots that may be added to a game scene to suit a timid player may be defined. As another example, a maximum speed of motion an adversarial foe may use against a PC may be defined to constrain how quickly the ML model may cause the foe to move against an aggressive player's PC. Yet again, the sequence of scenes of a game may be defined to not be interrupted or changed. Yet again, maximum time periods a particular scene may be presented and played may be defined for timid and aggressive players. Essentially, the same overall game narrative/story remains inviolable by use of the tent poles, with only smaller game threads/modifications such as those described herein being variable based on gamer play style. Moving to state 702, the game level/thread is changed according to the learned gamer style within the tent pole constraints. If desired, depending on the gamer's play style and current success or lack thereof, the game may change from first person to third person at state 704 in which the gamer no longer controls the PC but instead merely spectates the game, with the PC being controlled by a ML agent executed by the game engine.

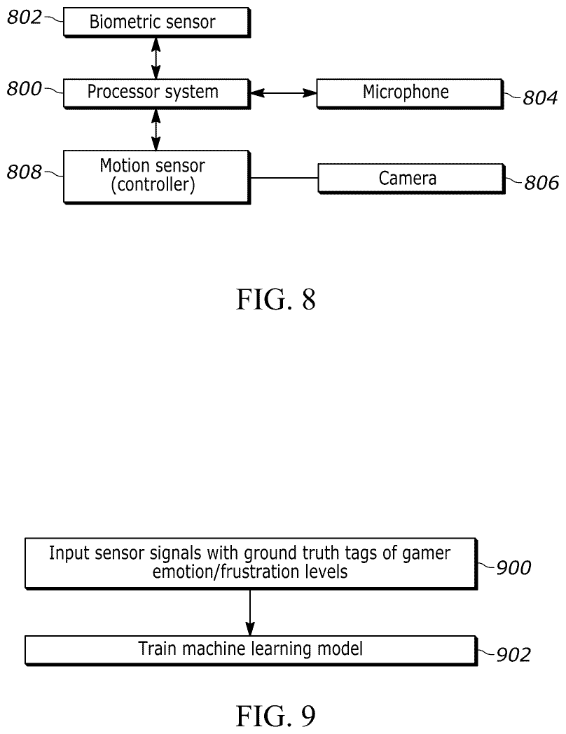

FIG. 8 illustrates a system for inferring gamer frustration and FIG. 9 illustrates a technique for training a ML model to use the system of FIG. 8 to detect frustration, to support reverting game presentation to the level/thread tailored to cater to the gamer's style of play. A processor system 800 in FIG. 8 may access one or more of a biometric sensor 802 engaged with the gamer, such as a heart rate sensor or perspiration sensor, and a microphone 804 to detect voice signals from the gamer that may indicate stress as inferred from, e.g., high pitch. A camera 806 may provide images to the processor system 800 that may indicate facial expressions correlatable to frustration or anger. Also, one or more motion sensors 808 may provide input to the processor system 800 indicating motion of the controller shown in FIG. 2 that may indicate whether the controller was thrown or thrust hard against the floor again to infer negative emotion on the part of the gamer.

State 900 of FIG. 9 indicates that a ML model may be trained to identify gamer emotion from the system in FIG. 8 by inputting a training set of data to the model and training the model on the training set at state 902. The training set may include signals that can be generated by any of the sensors in FIG. 8 along with ground truth annotation of gamer emotion and/or frustration and/or anger.

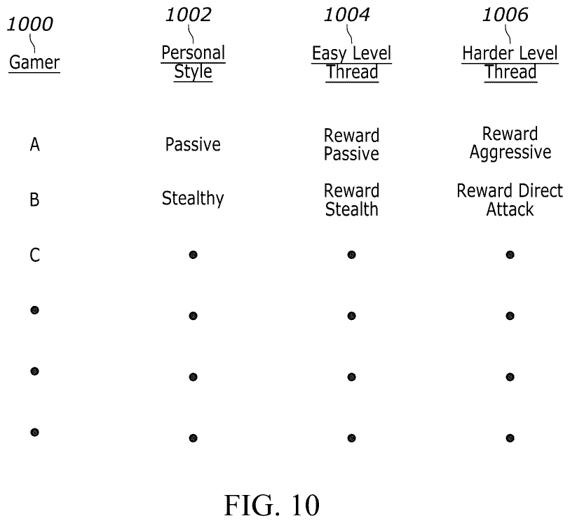

FIG. 10 illustrates the above principles in tabular form that may be stored by any processor or processor system herein. Plural gamers are identified in the first column 1000 along with their respective personal game play styles in the second column 1002. The third column 1004 indicates the respective styes of “easy” threads for each gamer, i.e., threads tailored for the gamers'respective styles, while the fourth column 1006 indicates the respective styes of more difficult threads for each gamer, i.e., threads tailored to penalize the gamers'respective styles.

Thus, for gamer “A” who has a passive style, the easy thread of a computer game may reward passive play while the harder thread may reward aggressive play. For a gamer “B” with a stealthy style of play, the easy thread may reward stealth play while the harder thread may reward direct attack strategies.

While the particular embodiments are herein shown and described in detail, it is to be understood that the subject matter which is encompassed by the present invention is limited only by the claims.

What is claimed is:

1. An apparatus comprising:
at least one processor system configured to:
establish a first game level style of a computer simulation to be consistent with identified play style of a first gamer, the play style of the first gamer comprising a passive style, the first game level style rewarding passive play;
responsive to game play success of the first gamer at the first game level style, change to a second game level style comprising rewarding aggressive play; and
responsive to success of the first gamer playing the second game level style not satisfying a threshold and/or responsive to identifying negative emotion of the first gamer, revert to the first game level style.

2. The apparatus of claim 1, wherein the processor system is configured to, responsive to identifying negative emotion of the first gamer, revert to the first game level style, wherein the negative emotion comprises frustration.

3. The apparatus of claim 1, wherein the processor system is configured to, responsive to identifying negative emotion of the first gamer, revert to the first game level style, wherein the negative emotion comprises anger.

4. The apparatus of claim 1, wherein the passive style comprises a strategy of fleeing from danger in the computer simulation.

5. The apparatus of claim 1, wherein the passive style comprises a strategy of hiding from danger in the computer simulation.

6. The apparatus of claim 1, wherein the aggressive play comprises a strategy of confronting danger in the computer simulation.

7. The apparatus of claim 1, wherein the processor system is configured to execute a machine learning (ML) model to identify the play style of the first gamer.

8. The apparatus of claim 1, wherein the processor system is configured to, responsive to success of the first gamer playing the second game level style not satisfying a threshold, revert to the first game level style.

9. An apparatus comprising:
at least one computer memory that is not a transitory signal and that comprises instructions executable by at least one processor system to:
identify a game play style of a first gamer;
present a computer simulation at a first level rewarding the game play style of the first gamer;
responsive to success of the first gamer playing the simulation at the first level, present the computer simulation at a second level penalizing the game play style of the first gamer; and
revert to presenting the computer simulation at the first level responsive to the first gamer playing at the second level not satisfying a threshold of success and/or responsive to the first gamer exhibiting negative emotion.

10. The apparatus of claim 9, wherein the instructions are executable to:
revert to presenting the computer simulation at the first level responsive to the first gamer playing at the second level not satisfying a threshold of success.

11. The apparatus of claim 9, wherein the instructions are executable to:
revert to presenting the computer simulation at the first level responsive to the first gamer exhibiting negative emotion.

12. The apparatus of claim 11, wherein the negative emotion comprises anger.

13. The apparatus of claim 11, wherein the negative emotion comprises frustration.

14. The apparatus of claim 9, wherein the game play style of the first gamer comprises a strategy of fleeing from danger in the computer simulation.

15. The apparatus of claim 9, wherein the game play style of the first gamer comprises a strategy of hiding from danger in the computer simulation.

16. The apparatus of claim 9, wherein the second level rewards a strategy of confronting danger in the computer simulation.

17. The apparatus of claim 9, wherein the instructions are executable to execute a machine learning (ML) model to identify the game play style of the first gamer.

18. A method comprising:
tailoring presentation of a computer simulation to reward a game style of a first gamer that is learned by a machine learning (ML) model from game play of the first gamer; and
tailoring presentation of the computer simulation to penalize the game style of the first gamer responsive to the first gamer achieving success satisfying a threshold.

19. The method of claim 18, comprising reverting to tailoring the computer simulation to reward the game style of the first gamer responsive to the first gamer not achieving success satisfying a threshold.
